(19) United States
(12) Patent Application Publication
(10) Pub. No.: US 2006/0177624 A1
(43) Pub. Date: Aug. 10, 2006

(54) Injectant-nonmetallic composite and method

(76) Inventors: Gnel Gevorkyan, Gilbert, AZ (US); Onnick Arakelian, Fresno, CA (US); Sarkis Oundjian, Chanlder, AZ (US)

Correspondence Address: Onnik ARAKELIAN, Eureak Gems, LLC;c/o Allen Funeral Home, 1130 S. Horne, Mesa, AZ, 85204, US

(21) Appl. No.: 11/397,820

(22) Filed: Apr. 3, 2006

Related U.S. Application Data
(63) Continuation of application No. 11/292,898, filed on Dec. 3, 2005.
(60) Provisional application No. 60/633,495, filed on Dec. 6, 2004.

(51) Int. Cl. B29C 45/14; B44C 1/26

(52) U.S. Cl. 428/67; 264/259

(57) ABSTRACT

In a method of making an injectant-nonmetallic composite having a fracturable nonmetallic base material: a block of fracturable nonmetallic base material is encased in an investment material to an extent that the block is held together when fractured; the block is fractured; a bonding material is introduced into the fractures created in the block to bond the block together when the block is no longer encased in the investment material; the block is removed from the investment material and encased in a second investment material to an extent that the block is held together when the bonding material is removed from the fractures in the block; the bonding material is removed from the fractures in the block; the block is heated; and a molten injectant is introduced into the fractures and solidified to form an injectant-nonmetallic composite.

This patent application claims the priority and benefit of co-pending US patent application Ser. No. 11/292,898 filed Dec. 3, 2005 which claims priority and benefit of U.S. provisional application 60/633,495, filed Dec. 6, 2004, which are incorporated herein in their entirety by reference.

### BACKGROUND OF THE INVENTION

The method of the subject invention relates to making a composite having a fracturable nonmetallic base material and to the product made by the method of the subject invention. While the method of the subject invention and the composite of the subject invention may be used for other applications, the method and the composite of the subject invention are particularly well suited for forming a metallic-nonmetallic composite to be used in the jewelry industry as a high quality gem for cabbing and inlay work. Metallic-nonmetallic composites exits in nature and historically these naturally occurring metallic-nonmetallic composites have been mined and used in jewelry. The method of the subject invention may be used to form metallic injectant-nonmetallic composites that are visually the same as or similar in appearance to naturally occurring metallic-non-metallic composites as well as to form other injectant-nonmetallic composites such as but not limited to metallic injectant-nonmetallic composites that are not visually the same as or similar in appearance to naturally occurring metallic-nonmetallic composites and nonmetallic injectant-nonmetallic composites.

### SUMMARY OF THE INVENTION

In the method of the subject invention a fracturable nonmetallic base material is used to form an injectant-nonmetallic base material composite. As used in the specification and claims, the term “fracturable nonmetallic base material” includes fracturable materials that are nonmetallic; that are essentially nonmetallic and contain only traces of metal; that are substantially nonmetallic (contain less than 10% metal by weight); or that are for the most part are nonmetallic (contain less than 50% by weight metal).

In the method of the subject invention a block of fracturable nonmetallic base material is encased in a first investment material to an extent that the block of nonmetallic base material is held together when fractured. Fractures are then created in the block of nonmetallic base material by heating and quenching the investment encased block to stress and fracture the block or by otherwise stressing and fracturing the block. A liquid bonding material, such as molten wax, is introduced into the fractures created in the block of nonmetallic base material and allowed to solidify to an extent that the block of nonmetallic base material is held together when the block of nonmetallic base material is no longer encased in the first investment material. The block of nonmetallic base material is then removed from the first investment material and encased in a second investment material to an extent that the block of nonmetallic base material is held together when the solidified bonding material is removed from the fractures in the block of nonmetallic base material. The solidified bonding material is then removed from the fractures in the block of nonmetallic base material by heating the bonding material to a temperature at which the bonding material burns or vaporizes or by otherwise removing all or substantially all of the bonding material from the fractures. The block of nonmetallic base material is then heated to a temperature at which the fractures in the block of nonmetallic base material can receive a molten injectant without prematurely cooling the molten injectant so that the fractures can be filled or substantially filled with the molten injectant. The molten injectant is then introduced into the fractures in the block of nonmetallic base material so that the fractures become filled or substantially filled with the injectant. The molten injectant is allowed to solidify into a solidified injectant within the fractures to the extent that the solidified injectant and the block of nonmetallic base material form an injectant-nonmetallic base material composite. This injectant-nonmetallic base material composite is removed from the second investment and the nonmetallic base material of the injectant-nonmetallic base material composite is stabilized by introducing a bonding material into the nonmetallic base material. The injectant-nonmetallic base material composite block is then typically cut into slices, e.g. to be used as a gem material in jewelry.

The molten injectant is forcefully introduced (injected) into the fractures in the block of nonmetallic base material: by placing the injectant under pressure; by drawing the molten injectant into the fractures by creating at least a partial vacuum within the fractures; or by concurrently placing the molten injectant under pressure and drawing the molten injectant into the fractures by creating at least a partial vacuum within the fractures.

The fracturable nonmetallic base material may be any of numerous fracturable nonmetallic materials such as but not limited to a group of fracturable nonmetallic materials that includes quartz, glass, onyx, stones, semi-precious stones, and precious stones. The injectant of the injectant-nonmetallic base material composite may be any of numerous materials that can be liquefied and subsequently solidified such as but not limited to: metallic materials such as precious metals, precious metal alloys, and other metals and metal alloys; nonmetallic materials such as thermosetting and thermoplastic polymeric materials; and materials such as thermosetting and thermoplastic polymeric materials containing one or more pigments and/or metallic fillers.

### BRIEF DESCRIPTION OF THE DRAWINGS

FIG. 1 is a schematic perspective view of a block of the injectant-nonmetallic composite of the subject invention created by the method of the subject invention.

FIG. 2 is a schematic perspective view of a slice or slab of the injectant-nonmetallic composite of the subject invention.

FIG. 3 is a schematic perspective view of a block of fracturable nonmetallic base material.

FIG. 4 is a schematic perspective view of a perforated sleeve and closure that may be used in the method of the subject invention for forming the injectant-nonmetallic composite of the subject invention.

FIG. 5 is a schematic elevation of the perforated sleeve and closure of FIG. 4 and an investment material that is contained within the sleeve (all in section) and of the block of fracturable nonmetallic base material of FIG. 3 (not in section) that is contained within the perforated sleeve and embedded in the investment material (e.g. gypsum).

FIG. 6 is a schematic elevation of the perforated sleeve of FIG. 4 and the investment material that is contained within the sleeve (both in section) and of the block of fracturable nonmetallic base material of FIG. 3 (not in section) that is contained within the perforated sleeve and embedded in the investment material (e.g. gypsum) which has holes drilled therein.

FIG. 7 is a schematic elevation of the perforated sleeve of FIG. 4 and the investment material that is contained within the sleeve (both in section) and of the block of fracturable nonmetallic base material of FIG. 3 (not in section) now fractured, contained within the perforated sleeve, and embedded in the investment material (e.g. gypsum) which has holes drilled therein. The perforated sleeve is oriented for introducing a liquid bonding material into the now fractured block.

FIG. 8 is a schematic perspective view of the block of fracturable nonmetallic base material, which is fractured and held together with the bonding material.

FIG. 9 is a schematic elevation of a second sleeve and closure and a second investment material that is contained within the second sleeve (all in section) and of the fractured block of fracturable nonmetallic base material (not in section) that is contained within the second sleeve and embedded in the second investment material (e.g. gypsum).

FIG. 10 is a schematic elevation of the second sleeve and the second investment material that is contained within the second sleeve (both in section) and of the fractured block of fracturable nonmetallic base material (not in section) that is contained within the second sleeve and embedded in the second investment material (e.g. gypsum). The second sleeve is oriented for introducing a molten injectant into the fractured block of fracturable nonmetallic base material.

FIG. 11 is an elevation of an injectant pressurizing assembly of the subject invention with the raw potato and tube of the assembly in section and the rod and raw potato core of the assembly not in section. The raw potato core is engaged by the rod and ready to be inserted into the reservoir formed in the second investment material, by pushing the rod into the tube, to force a molten injectant in the reservoir into the fractures of the fracturable nonmetallic base material.

FIG. 12 is an elevation of a vacuum forming apparatus of the subject invention for forming at least partial vacuum in the fractures of the block of fracturable nonmetallic base material to draw a molten injectant into the fractures in accordance with one embodiment of the method of the subject invention.

### DESCRIPTION OF THE PREFERRED EMBODIMENTS

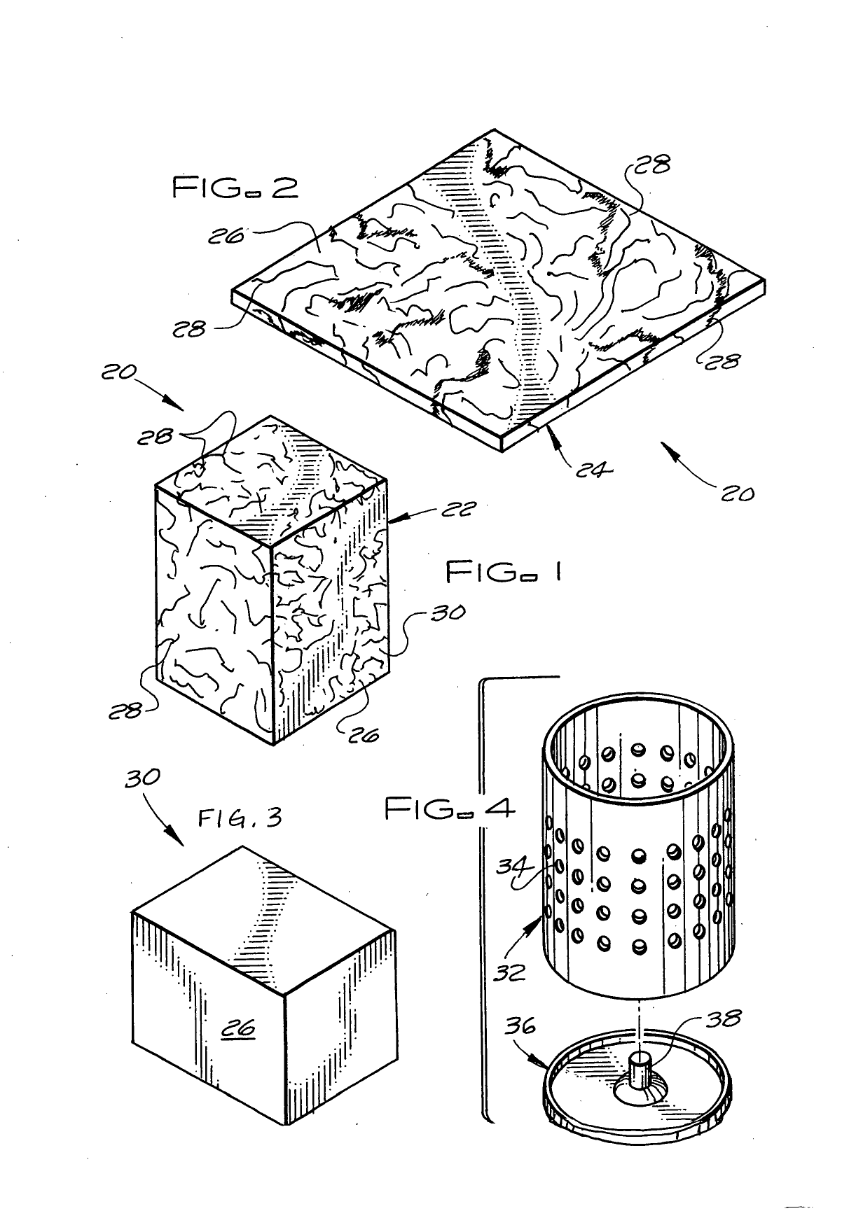

The composite 20 of the subject invention (schematically shown in block form 22 in FIG. 1 and in slab or slice form 24 in FIG. 2) includes a fracturable nonmetallic base material 26 that has been fractured and a solidified injectant 28 that occupies the fractures in the fracturable nonmetallic base material. The fracturable nonmetallic base material 26 may be any of numerous fracturable nonmetallic materials such as but not limited to a group of fracturable nonmetallic materials that includes quartz, glass, onyx, stones, semi-precious stones, and precious stones. The injectant 28 is a material that typically exhibits a characteristic luster or some other visually pleasing characteristic, but is not limited to such materials. The injectant 28 can be changed from a solid state to a molten state (liquid state) by being heated above a certain temperature and returned to a solid state by being cooled below that temperature. The injectant 28 may be a metallic material such as but not limited to any of a group of metallic materials that includes copper, iron, lead, gold, silver, platinum, an alloy including of any one or more of the aforementioned metals (e.g. brass which is copper and zinc), and other metal alloys as well as metallic alloys of at least one metal and one or more nonmetals that exhibits metallic properties (e.g. steel which is iron and carbon). The injectant may also be a nonmetallic material such as but not limited to a thermoplastic or a thermosetting polymeric materials (e.g. thermoplastic or thermosetting polymeric material that has a pleasing appearance or contains one or more pigments that provide the material with a pleasing appearance) or a material such as but not limited to a thermoplastic or thermosetting polymeric material having one or more pigments and/or one or more metallic fillers to add color and/or luster to the materials, etc. The injectant 28 occupies fractures in the fracturable nonmetallic base material 26 including minute or microscopic portions of the fractures in the base material as well as portions of the fractures ranging up to several millimeters or more in width and typically completely fills or substantially completely fills such fractures. The variety of and variations in the fractures (e.g. length, width, degree and number of bifurcations, etc.) are determined by the fracturable nonmetallic base material 26 used and by the techniques used to create the fractures in the fracturable nonmetallic base material 26. The solidified injectant 28 in the composite 20 typically appears as veins in the surfaces of the fracturable nonmetallic base material 26. Typically, the finished product is a slab or slice 24 of the injectant-nonmetallic base material composite 20 such as that shown in FIG. 2 which has been cut from a block 22 of the injectant-nonmetallic base material composite such as that shown in FIG. 1 to a specified thickness for a desired application (e.g. for use as cabbing or an inlay).

A first example of the method of the subject invention for making an injectant-nonmetallic base material composite 20 follows:

Step 1: Provide a block 30 of fracturable nonmetallic base material 26 such as but not limited to a stone, a semi-precious stone, a precious stone, quartz (SiO₂), glass (SiO₂), or onyx (SiO₂) e.g. a fracturable nonmetallic material. The fracturable nonmetallic base material 26 is either obtained or cut to a desired shape and size (e.g. a block 30 of rectangular cross section or cylindrical block) for processing in accordance with the method of the subject invention. As shown in FIG. 3, the fracturable nonmetallic base material 26 is in a rectangular block form (e.g. a block 3 inches by 3 inches by 4 inches).

Step 2: Provide a sleeve 32 open at both ends and having a series of annular rows of openings 34 in its tubular sidewall (e.g. a perforated cylindrical metal sleeve that is commonly used in the investment casting industry) and a closure 36 with a centrally located pin 38 for mounting on one end of the sleeve. Preferably, the pin 38 has a diameter to form a hole 46 through the investment material 40 that is as small as practical and still permit the introduction of a liquid bonding material 48 into the block 30 of then fractured nonmetallic base material 26 in accordance with Step 10. The diameter of the hole 46 formed in the investment material 40 is formed to be as small as practical so that the investment material 40 can better hold the block 30 of fracturable nonmetallic base material 26 together when that block 30 is fractured in Steps 7, 8, and 9.

Step 3: Bond the block 30 of fracturable nonmetallic base material 26 to the free end of the pin 38 with a bonding material such as but not limited to jewelry grade wax and with the block preferably centered on the end of the pin.

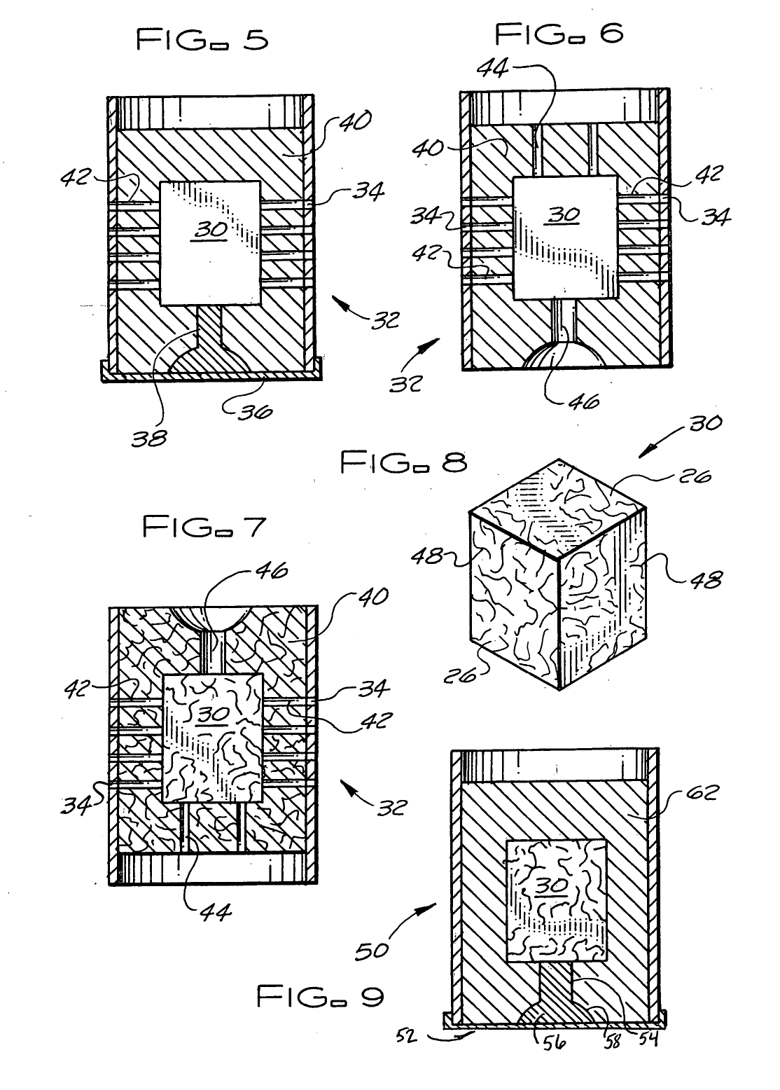

Step 4: Insert the block 30 of fracturable nonmetallic base material 26 into the sleeve 32, to position the block as shown in FIG. 5, by mounting the closure 36 on one end of the sleeve. Tape over the openings 34 in the sleeve 32, e.g. with masking tape not shown, to temporarily seal the openings so that an investment material 40 can be introduced into the sleeve in liquid form.

Step 5: Introduce the investment material 40 into the sleeve 30 in liquid form to encase and solidity about the block 30 of fracturable nonmetallic base material 26. Encase the block 30 of fracturable nonmetallic base material 26 within the investment material to the extent that the solidified investment material 40 will hold the block 30 together when the block 30 is fractured. After the investment material 40 has solidified, the tape sealing the openings 34 is removed from the sleeve 32. An example of an investment material 40 used for this purpose is FASTFIRE™ 15-investment material marketed by Whipmix of Louisville, Ky.

Step 6: Drill holes 42 in the investment material 40 that extend from the openings 34 in the sleeve 32 to the sides of the block 30 of fracturable nonmetallic base material 26. Drill holes 44 (e.g. four holes) in the investment material 40 that extend from the exposed end of the investment material to a first end of the block 30 of fracturable nonmetallic base material 26. For ease of drilling, the holes 42 and 44 should be drilled before the investment material 40 fully hardens. The holes are formed in the first investment 40 to create direct conduits from the outside surface of the sleeve 32 and investment material to the outer surfaces of the block 30 while leaving sufficient investment material 40 in place to hold the block 30 of fracturable nonmetallic base material 26 together after the block has been fractured later in the process. In the subsequent heating step, these direct conduits function as thermal channels to permit the more effective heating and cooling of the block 30 of fracturable nonmetallic base material 26 at spaced apart locations on the block. This heating and cooling of the block 30 at spaced apart locations facilitates the formation of the fractures in the block 30 of fracturable nonmetallic base material 26 as it is heated and then quenched or otherwise rapidly cooled. After the investment material 40 hardens, the closure 36 is removed from the end of the sleeve 32 and the rod 38 from within the investment material 40 to create a hole 46 through the investment material 40 to the second end of the block 30 as shown in FIG. 6.

Step 7: Heat the block 30 of fracturable nonmetallic base material 26 in a kiln, while the block 30 is within the sleeve 32 and investment material 40, to a temperature sufficiently high (e.g. 2400° F.) to cause fractures in the block when the block in quenched e.g. rapidly cooled in ice water. While the block 30 of fracturable nonmetallic base material 26 is thus heated, quench the block 30 in ice water or otherwise rapidly cool the block to cause stresses in the block that result in fractures within the block. The holes 34 through the sleeve and 42, 44 through the investment material 40 to the sides and ends of block 30 allow the ice water to come into direct contact with the block 30 to more rapidly cool the block in spaced apart locations and create greater stresses within the block that typically result in violent stress fracturing.

Step 8: Repeat heating and quenching cycle of Step 7 until the desired degree of fracturing has occurred throughout the block 30 of fracturable nonmetallic base material 26.

Step 9: Once the desired degree of fracturing has occurred throughout the block 30 of fracturable nonmetallic base material 26, the sleeve 32, the block 30, and investment material 40, which typically is also fractured but still able to hold the block 30 together within the sleeve 32, are again heated (e.g. to 500 to 600° F.) to drive off any water remaining within the fractures of the block 30 of fracturable nonmetallic base material 26.

Step 10: The sleeve is then oriented with the hole 46 through the investment material 40 facing upward as shown in FIG. 7 and a liquid bonding material 48 (e.g. a molten jewelry grade wax) is then poured through the hole 46 and into the fractures extending throughout the block 30 of fracturable nonmetallic base material 26. Once the liquid bonding material 48 (e.g. molten wax) has completely filled the fractures or filled the fractures to the degree desired to hold the block 30 together, the liquid bonding material 48 (e.g. molten wax) is allowed to solidify and the solidified bonding material 48 now functions as a temporary adhesive to bond and hold together the pieces of the now fractured nonmetallic base material 26 forming the block 30.

Step 11: The block 30 and the investment material 40 are then removed from the sleeve 32, typically, by cutting the sleeve in half lengthwise. Once the block 30 and the investment material 40 have been removed from the sleeve 32, the investment material 40 is removed (typically by chiseling) from the block 30, which is now held together by the solidified bonding material 48 as shown in FIG. 8.

Step 12: Provide a sleeve 50 open at both ends, with or without a series of annular rows of openings in its tubular sidewall (e.g. a perforated or non-perforated cylindrical metal sleeve that is commonly used in the investment casting industry), and a closure 52 with a centrally located pin 54 for mounting on one end of the sleeve 50. Preferably, the pin 54 is mounted on a raised base portion 56 of the closure 52 that has a generally annular convex surface 58. As shown the sleeve 50 does not have a series of annular rows of openings in its tubular sidewall. The pin 54 has a diameter to form a hole 60 through an investment material 62 (introduced into the sleeve in Step 15) that is sufficiently large to function as a reservoir for the molten injectant to be introduced into the block 30 of fractured nonmetallic base material 26 in Step 20.

Step 13: Bond the block 30 of fractured nonmetallic base material 26 to the free end of the pin 54 with a bonding material such as but not limited to jewelry grade wax and with the block preferably centered on the end of the pin.

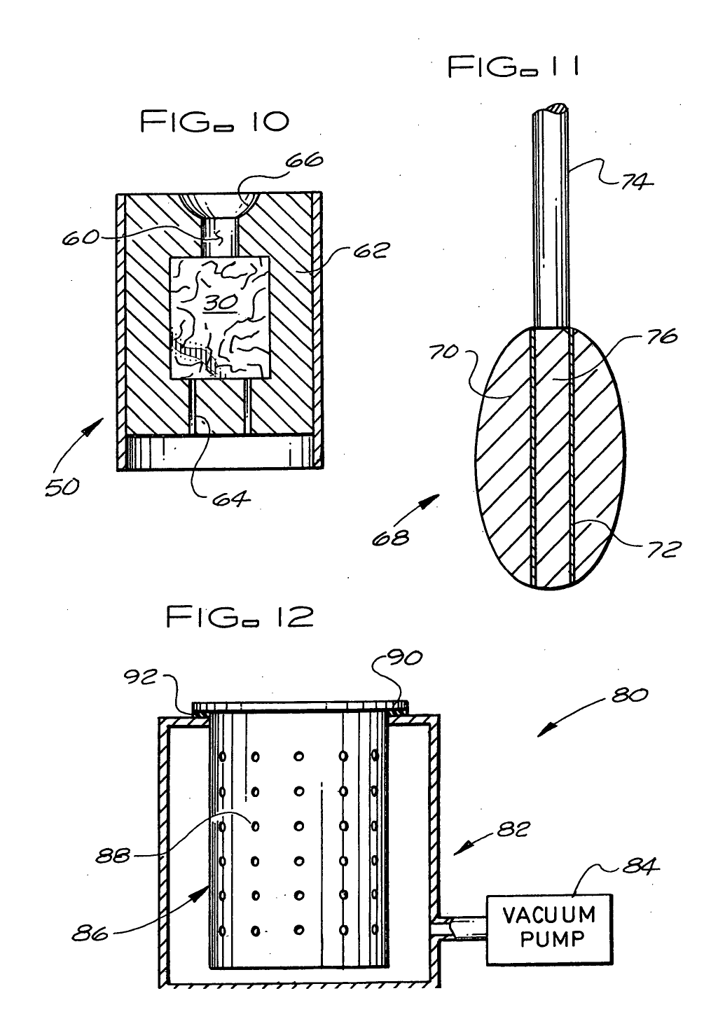

Step 14: insert the block 30 of fractured nonmetallic base material 26 into the sleeve 50, to position the block as shown in FIG. 9, by mounting the closure 52 on one end of the sleeve. If the sleeve 50 has openings, tape over the openings in the sleeve, e.g. with masking tape, to temporarily seal the openings so that an investment material 62 can be introduced into the sleeve in liquid form.

Step 15: Introduce an investment material 62 into the sleeve 50 in liquid form to encase and solidity about the block 30 of fractured nonmetallic base material 26. Encase the block 30 of fractured nonmetallic base material 26 within the investment material 62 to the extent that the solidified investment material 62 will hold the block 30 together when the bonding material 48 is removed from the fractures in the block. After the investment material 62 has solidified, any tape is removed from the sleeve 50. While the second investment material 62 is permeable to air, preferably, the molten injectant 28 does not pass to any great extent into the second investment material 62 and thus stops flowing outward from the block 30 at or about at the exterior surface(s) of the block 30. An example of an investment material used for this purpose is ASTRO-VEST™ investment material marketed by Ransom & Randolph of Maumee, Ohio.

Step 16: As an option to facilitate the introduction of the molten injectant 28 into the fractures of the block 30 of fractured nonmetallic base material 26, it is contemplated that holes 64 (e.g. four holes) may be drilled in the investment material 62 that extend from the exposed end of the investment material to a first end of the block 30 of fractured nonmetallic base material 26. For ease of drilling, the holes 64 may be drilled before the investment material 62 fully hardens. Remove the closure 52 from the end of the sleeve 50 and the rod 54 and base portion 56 from within the investment material 62 to create a hole 60 through the investment material 62 to the second end of the block 30. The hole 60 functions as a reservoir for the molten injectant in Steps 19 and 20 and the base portion 56 forms a cavity 66 in the investment material 62 that can be used for receiving an injectant pressuring apparatus such as the apparatus shown in FIG. 11 that can be used in Step 20.

Step 17: After the second investment material 62 has hardened and the closure 52 has been removed, the second sleeve 50, containing the block 30 of fractured nonmetallic base material 26 (held together by the bonding material 48) and the second investment material 62 is placed in a kiln and heated until the block 30 of fractured nonmetallic base material 26 reaches a desired temperature where the bonding material 48 (preferably jewelry grade wax) burns off or vaporizes (this is referred to in jewelry casting as wax burnout) and the fractures in the block 30 are free or substantially free of the bonding material 48 and open so that the fractures may receive a molten injectant 28 in Step 20. The block 30 of fractured nonmetallic base material 26, now held together within the sleeve 50 by the second investment 62, is heated to still higher temperatures until the fractured nonmetallic base material 26 reaches a desired temperature (e.g. for a molten metal injectant or a molten metal alloy injectant such as gold or a gold alloy about 2300° F. to about 2400° F.) that will allow the molten injectant 28 to be introduced into the fractures of the fractured nonmetallic base material 26 though the reservoir hole 60 and flow into the fractures, without prematurely solidifying, so that the fractures can be completely filled or filled to the degree desired with the molten injectant 28 before the molten injectant solidifies. In other words the block 30 of fractured nonmetallic base material 26 is heated to a temperature sufficiently high that the fractured nonmetallic base material 26 will not prematurely cool the molten injectant 28 introduced into the fractures of the fractured nonmetallic base material before the molten injectant has filled the fractures to the extent desired (preferably the fractures are completely or substantially completely filled by the molten injectant 28).

Step 18: Heat an injectant 28 (e.g. for a metal or metal alloy injectant in a kiln or similar heating apparatus) until the injectant is heated to a temperature above that at which the injectant becomes molten. The temperature to which the injectant 28 is heated should be sufficiently above the temperature at which the injectant begins to solidify that there will be a period over which the molten injectant can be introduced into the reservoir 60 and forced in molten form into the fractures of the block 30 of fractured nonmetallic base material 26 before the injectant begins to solidify.

Step 19: With the sleeve 50 oriented as shown in FIG. 10, introduce the molten injectant 28 into the reservoir 60. Preferably, the reservoir 60 is sized so that the reservoir 60 can contain a sufficient amount of molten injectant 28 that the fractures within the block 30 can be filled with the molten injectant 28 by filling or substantially filling the reservoir 60 with the molten injectant and emptying the reservoir 60 of molten injectant from one to three times.

Step 20: Force and/or draw the molten injectant 28 from the reservoir 60 into the fractures of the block 30 of fractured nonmetallic base material 26. The molten injectant 28 may be forced into the fractures of the block 30 by placing the molten injectant under pressure. The molten injectant 28 may be drawn into the fractures of the block 30 by creating at least a partial vacuum within the fractures of the block 30. The molten injectant 28 may be forced and drawn into the fractures of the block 30 by placing the molten injectant 28 under pressure and creating at least a partial vacuum within the fractures. The molten injectant 28 is forced and/or drawn into the fractures of the block 30 of fractured nonmetallic base material 26 until the fractures are filled or substantially filled with the molten injectant 28 or until the fractures are filled to the extent desired with the molten injectant 28. Capillary action can also contribute to the flow of the molten injectant 28 into the fractures of the block 30 to the extent desired (typically until the fractures are completely or substantially completely filled with the molten injectant 28). The molten injectant 28 is then allowed to solidify, bond together the pieces of the fractured nonmetallic base material 26 and form a block 22 of the injectant-nonmetallic composite 20 such as that shown in FIG. 1.

Step 21: After the sleeve 50, the second investment material 62, and the block 22 injectant-nonmetallic composite 20 have cooled sufficiently for handling, the block 22 of injectant-nonmetallic composite 20 and the second investment material 62 are removed from the sleeve 50, typically, by cutting the sleeve in half lengthwise. The investment material 62 is then removed from the block 22 of injectant-nonmetallic composite 20 (e.g. by chiseling).

Step 22: The fracturable nonmetallic base material 26 of the injectant-nonmetallic composite 20 is degraded during the heating and cooling cycles of the method. Thus, the block 22 of injectant-nonmetallic composite 20 may be and, preferably, is stabilized to strengthen and increase the hardness and durability the fracturable nonmetallic base material 26 of the composite 20 by a stabilizing procedure in common use in the jewelry industry. In the stabilizing process, the block 22 is typically soaked in a binder under pressure (e.g. a polymeric binder such as but not limited to an Opticon™ resin binder, or an epoxy, polyester, or polystyrene binder) so that the binder penetrates the fracturable nonmetallic base material 26 of the composite. However, other methods may be used to infuse or permeate the fracturable nonmetallic base material 26 of the composite 20 with a suitable binder.

Step 23: The stabilized block 22 of injectant-nonmetallic composite 20 may be cut into slabs or slices 24 of desired thicknesses and shapes such as shown in FIG. 2 for cabbing, inlays, or other applications and/or for further processing for a particular application.

One unique method of applying pressure to the injectant 28 in Step 20 is to utilize an injectant pressurizing assembly that includes: a housing that preferably has a convex surface that is complementary to the concave surface of the cavity 66 formed in the investment material 62 by the convex surface 58 of the closure base 56 to form a seal with the investment material; and a plunger with an external diameter substantially equal to the internal diameter of the reservoir 60 in the investment material 62. When introduced into the reservoir 60, the plunger forms a sliding and sealing fit with the sidewall of the reservoir 60. The plunger is slidably mounted in a bore of the housing and has a length that enables the plunger to be pushed into the reservoir 60 to place a molten injectant 28 within the reservoir 60 under pressure and force the molten injectant into the fractures within the block 30. Preferably, the plunger has a length that enables the plunger to be pushed into the reservoir 60, to place the molten injectant 28 under pressure and force the molten injectant into the fractures within the block 30, until the plunger comes in contact with the block 30. In this assembly, the transfer of thermal energy (heat) from the molten injectant 28 in the reservoir 60 to the plunger occurs at a sufficiently low transfer rate and/or in a sufficiently low amount that the plunger does not cool the molten injectant 28 within the reservoir 60 to the extent that the flow of the molten injectant 28 from the reservoir 60 into the fractures in the block 30 of fractured nonmetallic base material 26 is materially impeded by a cooling of the molten injectant 28 by the plunger. In a preferred embodiment of the pressurizing assembly, the plunger is made of a material having a low thermal conductivity so that the transfer of thermal energy (heat) from the molten injectant 28 in the reservoir 60 to the plunger occurs at a sufficiently low transfer rate and/or the plunger has a small mass that is readily heated with a sufficiently small transfer of thermal energy (heat) from the molten injectant 28 in the reservoir 60 to the plunger that the plunger does not cool the molten injectant 28 within the reservoir 60 to the extent that the flow of the molten injectant 28 from the reservoir 60 into the fractures in the block 30 of fractured nonmetallic base material 26 is materially impeded by a cooling of the injectant by the plunger.

An injectant pressuring assembly 68 that has been successfully used to force molten injectant 28 into the fractures of a block 30 of fracturable nonmetallic base material 26 in accordance with Step 20 is shown in FIG. 11. This injectant pressurizing assembly 68 includes: a raw potato 70, a tube 72, and a solid rod 74. The tube 72 is able to withstand the temperatures to which it is subjected, is typically is made of metal, and has an internal diameter equal to or substantially equal to the internal diameter of the reservoir 60 in the investment material 62. The rod 74 is able to withstand the temperatures to which it is subjected, is typically is made of metal, and has an external diameter that allows the rod to be received within the tube 72 for reciprocal movement within the tube. Preferably, the rod 74 has an external diameter that enables the rod to form a close sliding fit within the tube 72. The tube 72 is passed through the raw potato and a core 76 of potato is formed within the tube 72 that has an external diameter equal to or substantially equal to the diameter of the reservoir 60. Since the potato core 76 can be compressed when pushed into the reservoir 60, the potato core 76 may have a diameter somewhat greater than the diameter of the reservoir 60 to form a better seal between the potato core 76 and the reservoir 60.

In operation, after a molten injectant 28 has been introduced into the reservoir 60 in accordance with Step 19, the potato 70 is inserted into the cavity 66 with the core 76 centered over the reservoir 60 and preferably, with the potato in sealing engagement with the cavity 66 in the investment material 62. The rod 74 is then inserted into the tube 72 and into contact with a first end of the potato core 76. The rod 74 is then pushed into the tube 72 forcing a second end of the potato core 76 from the tube 72 and into the reservoir 60. As the second end of the potato core 76 is moved into the reservoir 60, into contact with the molten injectant 28 within the reservoir, and forced further into the reservoir 60 after making contact with the molten injectant 28, the continued movement of the potato core 76 into the reservoir 60 places the molten injectant 28 within the reservoir 60 under pressure and forces the molten injectant 28 into the fractures of the block 30 of fractured nonmetallic base material 26. If the second end of the potato core 76 comes into contact with the block 30, more molten injectant 28 is introduced into the reservoir 60 and the procedure set forth above in this paragraph is repeated with an injectant pressuring assembly 68 utilizing a new raw potato 70. Preferably, the procedure is repeated until a portion of the molten injectant 28 remains within the reservoir 60 and the second end of the potato core 76 does not come into contact with the block 30.

One unique method for drawing the molten injectant 28 into the fractures of the block 30 of fractured nonmetallic base material 26 in Step 20 is to utilize a vacuum forming apparatus 80 such as the vacuum forming apparatus of FIG. 12. The vacuum forming apparatus 80 includes a vacuum chamber 82 and a vacuum pump 84. Once the block 30 of fractured nonmetallic base material 26 is heated as in Step 17 to a temperature where the fractured nonmetallic base material 26 will not prematurely cool the molten injectant 28, a second sleeve 86 open at least at one end and having annular rows of openings 88 therein and containing the block 30 of fractured nonmetallic base material 26 with the bonding material removed and held together and within the housing by the second investment 62 is placed in the vacuum chamber 82 of the vacuum forming apparatus 80. A seal is formed between the upper flange 90 of the sleeve 86 and the vacuum chamber 82 by a gasket 92 so that a partial vacuum can be created within the vacuum chamber 82 by the vacuum pump 84. With the sleeve 86 sealed to the vacuum chamber 82, a partial vacuum formed within the vacuum chamber 82 by the vacuum pump 84 sets up a pressure differential between the reservoir 60 in the investment material 62 and the interior of the chamber 82 so that the partial vacuum within the chamber will draw air through the block 30 of now fractured nonmetallic base material 26, the second investment 62 (which is air permeable), and the perforations 88 in the sleeve 86. A partial vacuum is then created within the vacuum chamber 82 by turning on the vacuum pump 84 and a molten injectant 28 heated in accordance with Step 18 is poured into the reservoir 60 of the investment material 62 in accordance with Step 19. In accordance with Step 20, the pressure differential caused by the partial vacuum in the chamber 82 is sufficiently great to draw not only air but also the molten injectant 28 from the reservoir 60 into the fractures in the heated block 30 of fractured nonmetallic base material 26. Once the molten injectant 28 is drawn into the fractures of the block 30 of fractured nonmetallic base material 26 to fill the fractures or fill the fractures to the degree desired, the molten injectant 28 is allowed to solidify, bond together the pieces of the fractured nonmetallic base material 26, and form a block 22 of the injectant-nonmetallic composite 20. When needed to ensure the desired infilling of the fractures by the molten injectant 28, pressure can be applied to the molten injectant 28 in the reservoir 60 in addition to the pressure applied to the molten injectant in the reservoir 60 by the pressure differential between the ambient atmospheric pressure and the partial vacuum created within the vacuum chamber 82. Capillary action can also contribute to the flow of the molten injectant 28 into the fractures to the extent desired (typically until the fractures are completely or substantially completely filled with the molten injectant 28). While the second investment 62 is permeable to air, preferably, the molten injectant 28 does not pass through or to any substantial degree into the second investment material 62 and stops flowing outward at or about at the exterior surface(s) of the block 30 of fractured nonmetallic base material 26.

While not shown, the reservoir 60 created in the investment material 62 can be enlarged by initially drilling a hole in the block 30 of fracturable nonmetallic base material 26 before heating the block 30 in Step 7 and extending the reservoir into the block 30 of fracturable nonmetallic base material 26. One method of extending the reservoir for the molten injectant 28 is to form a core hole in the block 30 of fracturable nonmetallic base material 26 that passes from one surface of the block into and typically most of the way through but not completely through the block. The core hole thus formed becomes a reservoir into which the molten injectant 28 can be later introduced and forced and/or drawn into fractures created in the fracturable nonmetallic base material 26. The core hole in the block 30 is centered relative to the reservoir 60 in the investment material 62.

While commercially available kilns can be used to heat the block 30 of fracturable nonmetallic base material 26 during the heating and cooling cycles of the method to fracture the block 30, to heat the bonding material 48, and to heat the block 30 and the injectant 28, these kilns lack the heating capacity to rapidly heat these materials. Accordingly, it is preferred to utilize a kiln in the method of the subject invention that has at least four heating coils (e.g. a heating coil on each wall of the kiln including the door) and that has each coil separately supplied with 40 amp single phase power. The use of such a kiln greatly increases the productivity of the method of the subject invention by reducing the heating times for each heating phase of the method by periods of up to several hours.

In describing the invention, certain embodiments have been used to illustrate the invention and the practices thereof. However, the invention is not limited to these specific embodiments as other embodiments and modifications within the spirit of the invention will readily occur to those skilled in the art on reading this specification. For example, while only one reservoir for the molten injectant 28 is used in the embodiments discussed in the specification, for larger blocks 30 of fracturable nonmetallic base material 26, more than one reservoir could be used. While the fractures are created in Step 5 by heating and rapidly cooling the fracturable nonmetallic base material 26, the fracturable nonmetallic base material may be fractured by other means such as but not limited to impact, ultra sonic frequency, or heating the base material with a propane or other torch. While it is preferred to use a melted jewelry grade wax in Step 10, other bonding agents that can flow into the fractures can also be used such as but not limited to commercially available glues and adhesives and a vacuum can be formed in the fractures to facilitate the flow of the bonding material into the fractures. The fracturable nonmetallic base material 26 may be processed in blocks having shapes other than rectangular or cylindrical block shapes. Thus, the invention is not intended to be limited to the specific embodiments disclosed, but is to be limited only by the claims appended hereto.

What is claimed is:

1. A method of making an injectant-nonmetallic composite having a fracturable nonmetallic base material, comprising:
providing a block of nonmetallic base material that is fracturable;
encasing the block of nonmetallic base material in a first investment material to an extent that the block of nonmetallic base material is held together when fractured;
creating fractures in the block of nonmetallic base material;
introducing a liquid bonding material into the fractures created in the block of nonmetallic base material and allowing the liquid bonding material to solidify to an extent that the block of nonmetallic base material is held together when the block of nonmetallic base material is no longer encased in the first investment material;
removing the block of nonmetallic base material from the first investment material;
encasing the block of nonmetallic base material in a second investment material to an extent that the block of nonmetallic base material is held together when the solidified bonding material is removed from the fractures in the block of nonmetallic base material;
removing the solidified bonding material from the fractures in the block of nonmetallic base material;
heating the block of nonmetallic base material to a temperature at which the fractures in the block of nonmetallic base material can receive a molten injectant without prematurely cooling the molten injectant so that the fractures can be at least substantially filled with the molten injectant;
introducing the molten injectant into the fractures in the block of nonmetallic base material and substantially filling the fractures with the molten injectant; and
allowing the molten injectant to solidify into a solidified injectant within the fractures to the extent that the solidified injectant and the block of nonmetallic base material form an injectant-nonmetallic base material composite.

2. The method of making an injectant-nonmetallic composite having a fracturable nonmetallic base material according to claim 1, including:
removing the injectant-nonmetallic base material composite from the second investment.

3. The method of making an injectant-nonmetallic composite having a fracturable nonmetallic base material according to claim 2, including:
stabilizing the injectant-nonmetallic base material composite.

4. The method of making an injectant-nonmetallic composite having a fracturable nonmetallic base material according to claim 3, including:
cutting the injectant-nonmetallic base material composite into slices.

5. The method of making an injectant-nonmetallic composite having a fracturable nonmetallic base material according to claim 1, wherein:
the molten injectant is introduced under pressure into the fractures in the block of nonmetallic base material.

6. The method of making an injectant-nonmetallic composite having a fracturable nonmetallic base material according to claim 1, wherein:
the molten injectant is introduced into the fractures in the nonmetallic base material by drawing the molten injectant into the fractures by creating a partial vacuum within the fractures.

7. The method of making an injectant-nonmetallic composite having a fracturable nonmetallic base material according to claim 1, wherein:
the molten injectant is introduced into the fractures in the nonmetallic base material by placing the molten injectant under pressure and drawing the molten injectant into the fractures by creating a partial vacuum within the fractures.

8. The method of making an injectant-nonmetallic composite having a fracturable nonmetallic base material according to claim 1, wherein:
the fractures are created in the block of nonmetallic base material by heating the block of nonmetallic base material and quenching the heated block of nonmetallic base material to suddenly cool the block of nonmetallic base material and set up stresses within the block of nonmetallic base material that fracture the block of nonmetallic base material.

9. The method of making an injectant-nonmetallic composite having a fracturable nonmetallic base material according to claim 1, wherein:
subsequent to creating the fractures in the block of nonmetallic base material, the block of nonmetallic base material is heated to a temperature above a temperature at which the bonding material becomes liquid; and while the block of nonmetallic base material is at a temperature above the temperature at which the bonding material becomes liquid, the liquid bonding material is introduced into the fractures in the block of nonmetallic base material.

10. The method of making an injectant-nonmetallic composite having a fracturable nonmetallic base material according to claim 1, wherein:
the bonding material is removed from the fractures in the block of nonmetallic base material by heating the bonding material within the block of nonmetallic base material to a temperature at which the bonding material burns or vaporizes.

11. The method of making an injectant-nonmetallic composite having a fracturable nonmetallic base material according to claim 1, wherein:
the injectant is a metallic material.

12. The method of making an injectant-nonmetallic composite having a fracturable nonmetallic base material according to claim 1, wherein:
the injectant is a precious metal or a precious metal alloy.

13. The method of making an injectant-nonmetallic composite having a fracturable nonmetallic base material according to claim 1, wherein:
the injectant is selected from a group consisting of gold, gold alloy, silver, silver alloy, platinum, and platinum alloy.

14. The method of making an injectant-nonmetallic composite having a fracturable nonmetallic base material according to claim 1, wherein:
the injectant is a thermosetting or thermoplastic polymeric material.

15. The method of making an injectant-nonmetallic composite having a fracturable nonmetallic base material according to claim 14, wherein:
the thermosetting or thermoplastic polymeric material contains a metallic filler.

16. An injectant-nonmetallic composite product made by the method of claim 3, comprising:
a stabilized fracturable nonmetallic base material having fractures therein and a metallic injectant within the fractures.

17. The injectant-nonmetallic composite product according to claim 16, wherein:
the metallic injectant is a precious metal or a precious metal alloy.

18. The injectant-nonmetallic composite product according to claim 16, wherein:
the metallic injectant is selected from a group consisting of gold, gold alloy, silver, silver alloy, platinum, and platinum alloy.

19. An injectant-nonmetallic composite product made by the method of claim 3, comprising:
a stabilized fracturable nonmetallic base material having fractures therein and a thermoplastic or thermosetting polymeric material injectant within the fractures.

20. The injectant-nonmetallic composite product according to claim 19, wherein:
the thermoplastic or thermosetting polymeric material injectant is a thermoplastic or thermosetting polymeric material that contains metallic filler.
